(19) United States
(12) Patent Application Publication
(10) Pub. No.: US 2025/0376116 A1
(43) Pub. Date: Dec. 11, 2025

(54) MIRROR POSITIONING WITH ELECTROMAGNETS AND MAGNETOMETERS

(71) Applicant: Gentex Corporation, Zeeland, MI (US)

(72) Inventors: Ryan Barrido Balili, Holland, MI (US); Daniel James Weber, Kentwood, MI (US)

(21) Appl. No.: 18/739,495

(22) Filed: Jun. 11, 2024

(51) Int. Cl. B60R 1/04; B60R 1/12; G01B 7/30

(52) U.S. Cl. CPC B60R 1/04; B60R 1/12; G01B 7/30; B60R 2001/1223

(57) ABSTRACT

A rearview assembly includes a mount and a main unit coupled to the mount such that the main unit is articulable on the mount by rotation about three perpendicular axes. First and second electromagnets are positioned within one of the mount or the housing and a first magnetic field sensor is positioned within the other of the housing and the mount. A processor selectively activates the first and second electromagnets for separate generation of a first magnetic field and a second magnetic field. The processor receives first magnetic field information related to the first magnetic field and second magnetic field information related to the second magnetic field from the first magnetic field sensor and determines a rotational position of the main unit in relation to the mount about each of the three perpendicular axes based on the first and second magnetic field information.

### BACKGROUND

The present disclosure relates generally to a vehicle rearview assembly and more particularly, relates to an assembly with a sensor configured to determine the axis orientation information of a main unit of the assembly relative to a mount.

Various features have been introduced to different types of vehicular rearview assemblies that can be augmented by the capability to determine the location and orientation, or pose, of a body of the rearview with respect to a base and/or the vehicle interior. Permanent magnets and magnetic sensors have been introduced as solutions in the past. Such solutions, however, are limited to magnets or sensors in a ball of a single ball-socket joint and magnets or three-axis magnetometers on the electronic board of a mirror, which may not operate with multi-jointed mounts, may have accuracy limitations, and has the disadvantage of not being able to turn off the magnetic field to measure and account for background magnetic disturbances.

### SUMMARY

According to one aspect of the present invention, a rearview assembly for a vehicle includes a mount extending from a fixed location with respect to the vehicle and a main unit including a front face secured to a housing, the main unit being coupled to the mount such that the main unit is articulable on the mount by rotation about three perpendicular axes. First and second electromagnets are positioned within one of the mount or the housing in mutually spaced apart first locations and a first magnetic field sensor is positioned within the other of the housing and the mount. At least one processor is in communication with the first and second electromagnets and the first and second magnetic field sensors, the processor selectively activates the first and second electromagnets for separate generation of a first magnetic field in a first predetermined configuration and a second magnetic field in a second configuration, with the first magnetic field sensor alternately operably associated with the first magnetic field and the second magnetic field. The processor further receives first magnetic field information related to the first magnetic field and second magnetic field information related to the second magnetic field from the first magnetic field sensor and determines a rotational position of the main unit in relation to the mount about each of the three perpendicular axes based on the first and second magnetic field information.

According to another aspect of the present invention, a rearview assembly for a vehicle includes a mount extending from a fixed location adjacent a headliner of the vehicle and a main unit including a front face secured to a housing. The main unit is coupled to the mount such that the main unit is articulable on the mount by rotation about three perpendicular axes or translatable with respect to the mount along the three perpendicular axes. First and second electromagnets are positioned within the headliner in mutually spaced apart first locations and a first magnetic field sensor is positioned within the housing. At least one processor is in communication with the first and second electromagnets and the first and second magnetic field sensors. The processor selectively activates the first and second electromagnets for separate generation of a first magnetic field in a first predetermined configuration and a second magnetic field in a second configuration, with the first magnetic field sensor alternately operably associated with the first magnetic field and the second magnetic field. The processor further receives first magnetic field information related to the first magnetic field and second magnetic field information related to the second magnetic field from the first magnetic field sensor and determining a rotational position of the main unit in relation to the mount about each of the three perpendicular axes based on the first and second magnetic field information.

According to another aspect of the present invention, a rearview assembly for a vehicle includes a mounting structure extending from a fixed location with respect to the vehicle and a main unit including a front face secured to a housing. The main unit is coupled to the mount such that the main unit is articulable on the mount by rotation about three perpendicular axes. First, second, and third electromagnets positioned within one of the mounting structure or the housing in mutually spaced apart first locations and a first magnetic field sensor is positioned within the other of the housing and the mounting structure. At least one processor is in communication with the first, second, and third electromagnets and the first and second magnetic field sensors. The processor selectively activates the first, second, and third electromagnets for separate generation of a first magnetic field in a first predetermined configuration and a second magnetic field in a second configuration, with the first magnetic field sensor alternately operably associated with the first magnetic field and the second magnetic field. The processor further receives first magnetic field information related to the first magnetic field and second magnetic field information related to the second magnetic field from the first magnetic field sensor and determining a rotational position of the main unit in relation to the mount about each of the three perpendicular axes based on the first and second magnetic field information. According to a further aspect, the processor can measure ambient magnetic fields with the first, second, and third electromagnets deactivated and remove the effect of the ambient magnetic fields during measurement with at least one of the first, second, and third electromagnets in an activated state.

These and other features, advantages, and objects of the present device will be further understood and appreciated by those skilled in the art upon studying the following specification, claims, and appended drawings.

### BRIEF DESCRIPTION OF THE DRAWINGS

The present invention will become more fully understood from the detailed description and

the accompanying drawings, wherein:

FIG. 1 is a perspective view of a vehicle interior including a rearview assembly according to an aspect of the disclosure;

FIG. 2 is a perspective view of a rearview assembly according to an aspect of the disclosure with a main unit thereof in a first position relative to a mount;

FIG. 3 is a perspective view of the rearview assembly with the main unit in a second position relative to the mount;

FIG. 4 is a perspective view of the rearview assembly with the main unit in a third position relative to the mount;

FIG. 5 is a front perspective exploded view of the rearview assembly;

FIG. 6 is a schematic depiction of electromagnets in operable engagement with a magnetic sensor for use in the rearview assembly;

FIG. 7 is a schematic depiction of position detection using a first one of the electromagnets;

FIG. 8 is a schematic depiction of additional position detection using a second one of the electromagnets;

FIGS. 9A-9D are schematic depictions of sets of electromagnets activated in various combinations for generating different magnetic fields;

FIG. 10 is a perspective view of a rearview assembly according to a further aspect of the disclosure;

FIG. 11 is a perspective view of a rearview assembly according to a still further aspect of the disclosure;

FIG. 12 is a perspective view of a rearview assembly according to a still further aspect of the disclosure; and

FIG. 13 is a perspective view of a rearview assembly according to a still further aspect of the disclosure.

### DETAILED DESCRIPTION OF EMBODIMENTS

The present illustrated embodiments reside primarily in combinations of method steps and apparatus components related to a vehicle rearview assembly. Accordingly, the apparatus components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

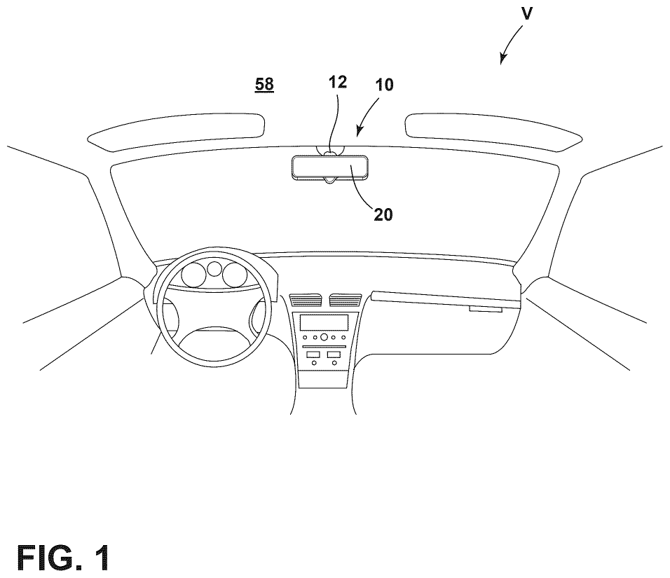

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Ordinal modifiers (i.e., “first”, “second”, etc.) may be used to distinguish between various structures of the disclosed transportation rack in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

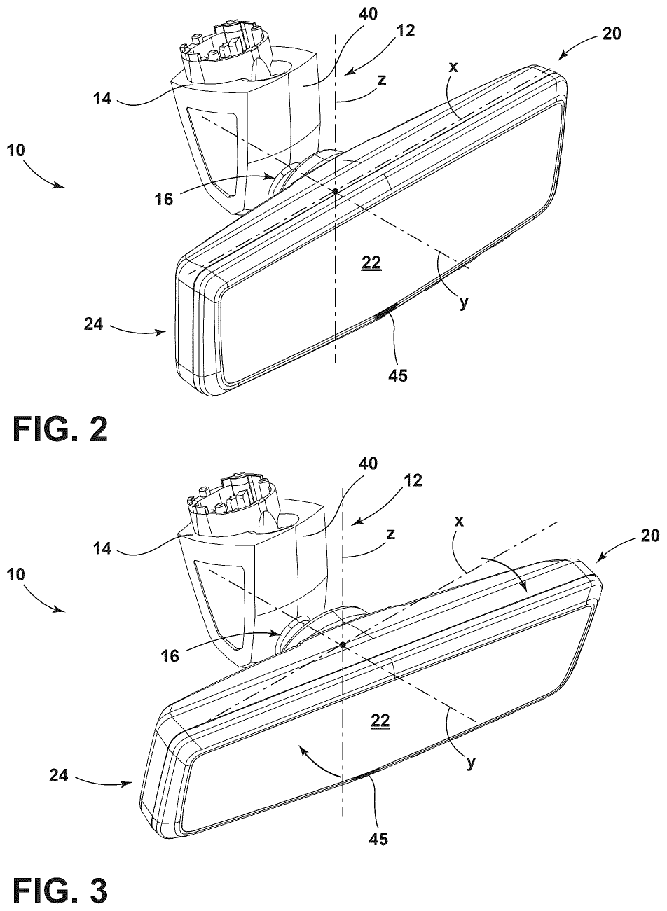

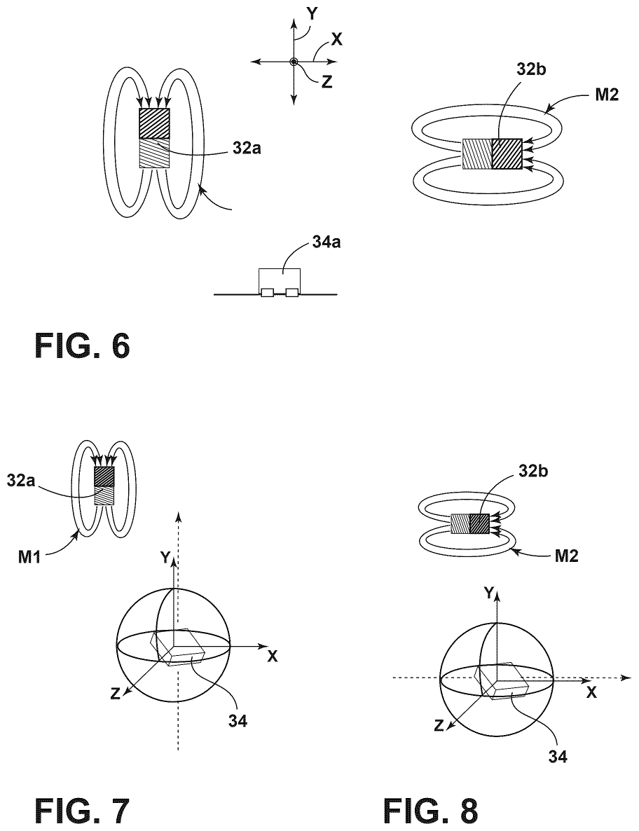

Referring to FIGS. 1-5, reference numeral 10 generally designates a rearview assembly for a vehicle V. The rearview assembly 10 includes a mount 12 extending from a fixed location with respect to the vehicle V and a main unit 20 including a front face 22 secured to a housing 24. The main unit 20 is coupled to the mount 12 such that the main unit 20 is articulable on the mount 12 by rotation about three perpendicular axes (x, y, and z in FIG. 2). First and second electromagnets 32a, 32b are positioned within one of the mount 12 or the housing 24 in mutually spaced apart first locations. A first magnetic field sensor 34a is positioned within the other of the housing 24 and the mount 12. As shown in FIGS. 2-5, in the illustrated implementation, the electromagnets 32a, 32b are positioned within the housing 24 of the main unit 20, with the sensor 34 positioned within the mount 12, with additional arrangements, consistent with the above description, being discussed further below. At least one processor 35 is in communication with the first and second electromagnets 32a, 32b and the first and second magnetic field sensor 34a. The processor 35 selectively activates the first and second electromagnets 32a, 32b for separate generation of a first magnetic field M1 (FIG. 6) in a first predetermined configuration and a second magnetic field M2 (FIG. 6) in a second configuration, with the first magnetic field sensor 34a alternately operably associated with the first magnetic field M1 and the second magnetic field M2. As can be appreciated, the electromagnet can be “activated” by the processor, either directly or indirectly, driving a current through coils associated with the electromagnet 32a, 32b to induce a magnetic field. This can be done in either direction through the coil, based on the polarity of the driving current, to generate the associate magnetic field M1, M2 in different directions, as discussed further below. The processor 35 further receives first magnetic field information 44a related to the first magnetic field M1 and second magnetic field information 44b related to the second magnetic field M2 from the first magnetic field sensor 34a and determines a rotational position of the main unit 20 in relation to the mount 12 about each of the three perpendicular axes (x, y, z) based on the first and second magnetic field information 44a, 44b.

As can be appreciated, the rearview assembly 10 described herein can be used in connection with vehicle V, particularly within the interior thereof, as shown in FIG. 1. In particular, rearview assembly 10 can be mounted adjacent a windshield W of vehicle V either by attachment of the mount 12 with the windshield W itself or to an additional component adjacent or mounted to the headliner 58 in an area above a top edge of the windshield W (such mounting may be made to a portion of the vehicle frame, a vehicle panel, or other support structure, for example, through one or more apertures in the headliner 58). As shown in FIG. 5, in particular, the mount 12 has a first end 14 and a second end 16 having a ball joint portion 18 defined thereon, and the housing 24 of main unit 20 includes a socket 26 disposed on an interior 28 thereof adjacent an aperture 30 disposed opposite the front face 22. The socket 26 rotatably receives the ball joint portion 18 such that the main unit 20 is articulable on the mount 12 by rotation about the three perpendicular axes (X, Y, and Z). The connection of the main unit 20 with the mount 12 by way of the receipt of the ball joint portion 18 within the socket 26 associated with the main unit 20 facilitates positioning of the face 22 of the main unit 20 in a desired position within the vehicle interior. In particular, this positioning is made adjustable by the ball-and-socket joint 36 defined by the attachment of the ball joint portion 18 with the socket 26. As can be appreciated, this adjustable positioning is realized by articulation of the socket 26 about the ball joint portion 18 and is limited in a range of motion about the Z-axis and a similar range of motion about the X-axis by the size of the aperture 30 relative to a stem 38 that connects the ball joint portion 18 to a base 40 of the mount 12. In various implementations, the respective ranges of rotational motion about each of the Z-axis and X-axis can be at least about 30° from the centered position shown in FIGS. 1 and 6, although other variations are possible. In this respect, FIG. 3 shows the main unit 20 rotated about each of the Z-axis and the X-axis by 15° from the center position of FIG. 2.

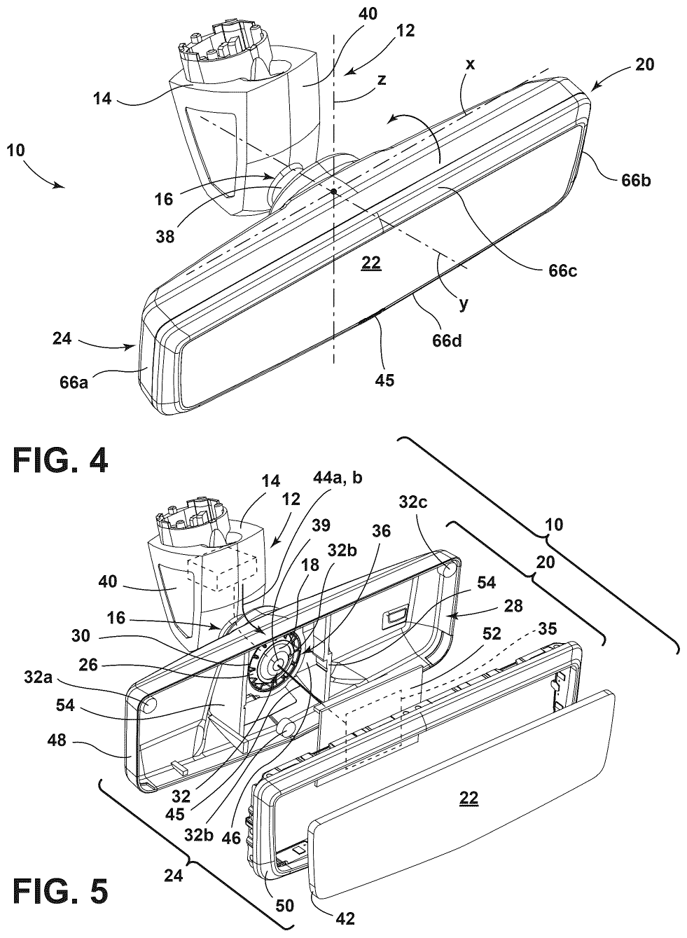

The structure of the joint 36 depicted herein can be such that the main unit 20 rotates freely on the ball joint 18 with respect to the Y-axis, although, in some aspects interference with the base 40 and/or adjacent parts of the vehicle (including, for example, the headliner 58) can restrict such rotation. In other aspects, additional structures within or associated with the joint 36 can restrict the Y-axis rotation of the main unit 20 to less than 360° about the ball joint portion 18 (for example, to within about 45° in either direction from the centered position of FIGS. 1 and 6) to prevent stressing or crimping of electrical connections between features within the interior 28 to the vehicle that pass through the joint 36 and the mount base 40. In this respect, FIG. 4 shows the main unit 20 rotated by about 10° on the Y-axis from the position of FIG. 3, discussed above.

In one example of the rearview assembly 10, described herein, the face 22 of the main unit 20 can be on a mirrored element 42 (FIG. 4) that is generally configured to present a reflected image of the view to the rear of vehicle to a driver and, accordingly, may be adjustable by movement of main unit 20 with respect to mount 12. In another example, the mirrored element 42 can be in the form of an electro-optic element such that the face 22 is associated with a transparent element that encloses an electro-optic medium that can be made more transmissible or less transmissible by application of an electric current thereto. In such an example, the mirrored element 42 defines the reflective surface. The main unit 20 may include an interior imager 45 exposed on the housing 24 adjacent the mirrored element 42, with such imager 45, in one example, being useable in connection with a driver monitoring system. In one respect, the capability to determine the position of the imager 45 can improve the accuracy of an associated driver monitoring or assistance system and, in some aspects may be necessary for certain features.

In another example, the face 22 of the main unit 20 may be defined on a display unit (that is schematically similar to the mirrored element 42 shown in the drawings for purposes of this discussion). In this respect, the rearview assembly 10 may be what may be referred to as a full-display mirror. As can be appreciated, the display unit may be capable of displaying a simulated mirror-image of the view to the rear of the associated vehicle (that may be captured by an appropriately-positioned video camera or the like) when the display is in an active state. Such an image may generally replicate that which would be available from a typical reflective mirror and can be supplemented with other information presented on the display unit. In one aspect, such an image may be responsive to the position of the main unit 20 about the mount 12, such that movement of the main unit 20 is linked with panning or rotation of the image presented on the display in the same way that movement of a mirrored surface changes the point-of-view of the reflected image. An example of such a system is discussed further in commonly assigned U.S. Pat. No. 10,525,890 (“the '890 Patent”), the entire contents of which are incorporated by reference herein.

As can be seen in FIGS. 5 and 6, the socket 26 can be coupled with the housing 24 by way of a mounting plate 46 that can be assembled within or integrally molded as a part of the housing 24. In the illustrated example, the housing 24 includes a front (i.e., with respect to the orientation of the rearview mirror assembly 10 within a vehicle) housing portion 48, which is shown in the form of a single-piece unit and can be made from a single piece of injection molded plastic or the like, although other materials are possible. In the depicted embodiment, the mounting plate 46 can be coupled with the rear housing 48 on an interior 28 thereof such that the socket 26 aligns with the aperture 30, which is also formed in the rear housing 48. In turn, the depicted mirrored element 42 (or, in the alternative the display unit) can be coupled to the rear housing 48 by way of a bezel 50 or other secondary housing piece that affixes to the rear housing 48 to complete and enclose the housing 24, thereby defining the interior 28 along with the mirrored element 42. In this and other examples, the housing 24 is structured so that the interior 28 is of a sufficient depth to retain internal structures of rearview assembly 10, including the joint 36 and other related structures, such as those related to the above-described electro-optic element or display substrate, the interior imager 45 and other elements known in the art or described later herein.

As can be appreciated, the variations of the rearview assembly 10, discussed above, in which the rearview assembly 10 incorporates at least one of a position-responsive display associated with the face 22 and/or an interior imager 45 for driver monitoring, the associated systems may advantageously utilize position information of the main unit 20 relative to the mount 12 (or, more broadly, with respect to the rest of the vehicle V). As further shown in FIGS. 5 and 6, such information may be obtained using the above-mentioned sensor 34a. In particular, the sensor 34a can be configured as a magnetic field sensor that can determine the location of the above-described magnetic fields M1, M2 defined by the electromagnets 32a and 32b (in various combinations described further below) with respect to the sensor 34a, independently and once appropriately calibrated. In this manner, the sensor 34a, which as mentioned above, is mounted within the mount 12, more particularly within a base 40 thereof, can be connected with the processor 35 by a communication line 45 that extends through an aperture 39 in the ball joint portion 18 for transmission of the magnetic field information 44a, 44b to the processor 35. The processor 35 can be mounted on and integrated with a printed circuit board (“PCB”) 52 that is mounted within the interior 28 of housing 24. In one aspect, the PCB 52 can be mounted by mechanical fasteners or the like to spaced-apart ribs 54 formed with the housing 48 with which the mounting plate 46 is connected or formed.

As further shown, the electromagnets 32a and 32b can be fixed within the housing 48 of the main unit 20 in locations along a lateral side thereof (electromagnet 32a) and toward the center, adjacent a bottom edge thereof (electromagnet 32b). In this arrangement, the electromagnets 32a and 32b move with the main unit 20 during articulation thereof about the ball joint portion 18, while the sensor 34a remains stationary within the vehicle V. As with the sensor 34a, discussed above, the electromagnets 32a and 32b can be electrically connected with the processor 35, either directly, or by way of a driver or controller connected therebetween, such that the processor 35 can control the activation and deactivation of the electromagnets 32a, 32b, such as by delivery of a predetermined current thereto. The advantage of using electromagnets is that the processor 35 can calibrate and modulate the strength of the magnetic fields M1, M2, etc. in real-time, or turn one or both off completely. In one aspect, the electromagnets 32a, 32b can be turned on and off in sequence in a controlled manner to generate the magnetic fields M1, M2 in sequence and having desired characteristics for detection using sensor 34a. In one aspect, sensor 34a can be a magneto-resistive three-axis magnetometer, such as those used for electronic compasses. In one aspect, such a sensor 34a can have a high degree of sensitivity that can effectively detect the desired magnetic field characteristics for determination of the positioning of the main unit 20 relative to the mount 12. The processor 35 can use the sensor 34a in the mount 12 to measure the magnetic field direction and location for each magnetic field M1 and M2, including based on the characteristics with which the fields M1 and M2 are generated, with respect to the sensor 34a to determine the position of the main unit 20, including with respect to tilt (on the X-axis), yaw (on the Z-axis), and roll (on the Y-axis). This scheme can also be used to determine absolute distances (i.e., the positioning of the main unit 20 along the X-, Y-, and Z-axes, which can be done, for example, using the calibrated strength of the measured field M1 and/or M2 or triangulation following known techniques used by magnetic gauging instruments for measuring thickness and/or proximity.

As shown in FIGS. 6-8, in one aspect, the selective activation of the first electromagnet 32a and the second electromagnet 32b can include activating the first electromagnet 32a with the second electromagnet 32b deactivated. In an implementation of the present system configured for such use, the electromagnets 32a and 32b can be oriented in different directions, as shown in FIG. 6. In one such implementation, electromagnet 32a can be configured such that the axis of symmetry of the magnetic field M1 associated therewith lies around the Y-axis, when electromagnet 32a is generated. Electromagnet 32b can be configured such that the axis of symmetry of the magnetic field M2 associated therewith lies around the X-axis when electromagnet 32b is generated. The processor 35 can determine the rotational position of the main unit 20 in relation to the mount 12 with respect to rotation about the X- and Z-axis based on the magnetic field information 44a from the first sensor 34a during activation of the first electromagnet 32a with the second electromagnet 32b deactivated. Notably, the additional rotation of the main unit 20 about the Y-axis between, for example, FIGS. 3 and 4 does not change the relative location of the magnetic field M1 with respect to first sensor 34a in the X-Z plane. Accordingly, additional information is needed for this determination such that, once the rotational position about the Y-axis is determined, the processor 35 can deactivate the first electromagnet 32a and activate the second electromagnet 32b with the first electromagnet 32a deactivated. This can allow the processor 35 to determine the rotational position of the main unit 20 in relation to the mount 12 about both the Y- and Z-axes based on the magnetic field information 44b from the first sensor 34a during activation of the second electromagnet 32b with the first electromagnet 32a deactivated. In particular, the extension of the magnetic field M2 generated by the second magnet 32b in a direction parallel to the first sensor 34a is such that the position and orientation of the magnetic field M2 relative to the sensor 34a can be used to determine the rotational position of the main unit 20 with respect to the mount 12 with respect to both the Y- and Z-axes, as discussed above. In this manner, the positioning of the first 32a and second 32b electromagnets with different respective magnetic field (M1, M2) orientations facilitates the above-described multi-axis position detection. In the present example, the respective directions of the magnetic fields M1, M2 associated with the first and second electromagnets 32a and 32b are substantially perpendicular (i.e., +/−5°), as discussed above.

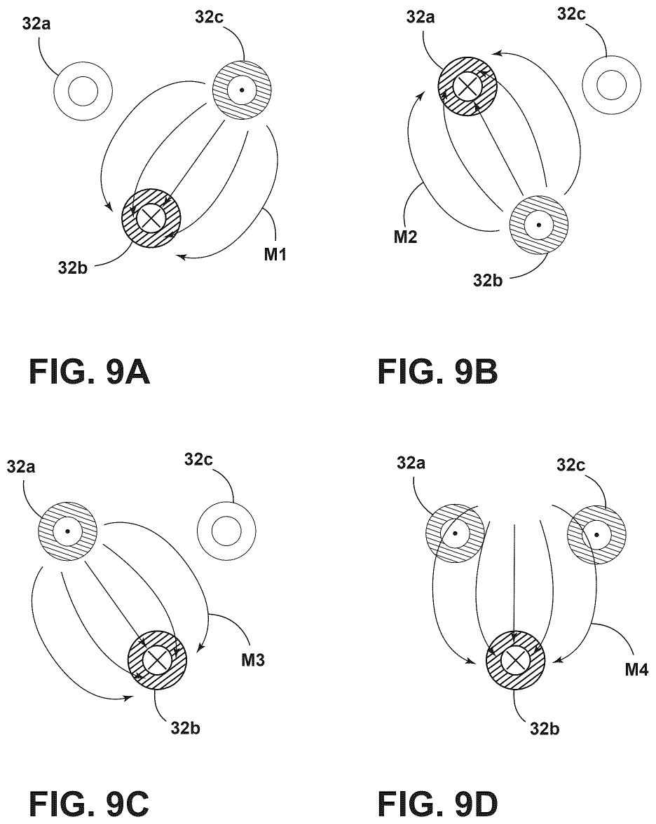

Turning to FIGS. 9A-9D, it is noted that the implementation of rearview assembly 10 shown in FIGS. 2-5 includes a third, optional, electromagnet 32c, which can be used to generate magnetic fields M1 and M2 having different positions and orientations by activating ones of the electromagnets 32a, 32b, and 32c simultaneously in various combinations for various angle measurements with respect to a magnetic field M1, M2 direction and strength. For example, as shown in FIG. 9A, by activating second electromagnet 32b and third electromagnet 32c in opposite polarities, a magnetic field M1 is generated along the driver's right side of the main unit 20. The sensor 34a can use the location and direction of the magnetic field M1 as a part of the determination of the position and orientation of the main unit 20 with respect to the mount 12. To gain additional information to complete the determination of the main unit 20 position, the processor 35 can activate selected ones of the electromagnets 32a, 32b, 32c in a different combination. For example, as shown in FIG. 9B, the processor 35 can activate the first electromagnet 32a and the second electromagnet 32b at opposite polarities to generate magnetic field M2 along the driver's left side of the main unit 20. When the sensor 34a receives the corresponding magnetic field information 44b, it is transmitted to the processor 35 for use in determining the position and orientation of the main unit 20 with respect to the mount 12. If additional information is still needed or desired, still further combinations of electromagnets 32a, 32b, and 32c can be activated at predetermined polarities to obtain the desired information, with it being noted that twenty-seven different magnetic fields M1, M2 . . . . M27 can be generated by activating various combinations of the depicted electromagnets 32a, 32b, 32c. In the additional depicted example of FIG. 9C, the polarities of the first electromagnet 32a and the second electromagnet 32b can be reversed from the combination shown in FIG. 9B. Further, as shown in FIG. 9D, all three electromagnets 32a, 32b, and 32c can be activated, with the first and third electromagnets 32a, 32c being of the same polarity and the second electromagnet 32b to generate a magnetic field M4 that extends centrally within the main unit 20.

The arrangement shown in FIGS. 1-5, wherein the electromagnets 32a, 32b, and 32c are positioned within the main unit 20 may be advantageous because it allows for a relatively high degree of spacing between the electromagnets 32a, 32b, and 32c, which allows for asymmetries in the generated magnetic fields M1, M2, etc. to be more detectible by the sensor 34a, which may make the calculations carried out by processor 35 less complicated and may reduce requirements of additional information by way of further generation and measurement of different magnetic fields. In this respect, it is further noted that the more electromagnets and sensors included in the disclosed assembly 10, the higher the accuracy of the positioning determination will be. As shown, the first and second electromagnets 32a and 32b can be positioned within the housing 24 at opposite first 66a and second 66b lateral sides toward an upper edge thereof 66c, and the third electromagnet 32c can be positioned toward a center of the housing 48 and toward a lower edge thereof 66d. Again, the incorporation of the electromagnets 32a, 32b, 32c into the main unit 20 has the advantage of allowing spacing of the magnets, creating simpler or uniform magnetic field directions, not alternating, around the sensor 34a area. Calculations and analysis may be simpler because the only fields that need to be measured are the ones in between the electromagnets 32a, 32b, 32c, and any fields that extend outside of the housing 48.

In an additional aspect, a soft iron or ferrite core, or piece, can be placed on the coil associated with one or more of the electromagnets 32a, 32b, 32c to amplify the associated magnetic field M1, M2, etc., which can allow the power supplied to the electromagnet 32a, 32b, 32c to be reduced. Additionally, a soft iron piece can be placed behind the sensor 34a as magnetic shield and/or an additional magnetic field source. It is additionally noted that the power provided to the electromagnets 32a, 32b, and 32c do not have to be by way of a direct current (“DC”). In this respect, an alternating current (“AC”) induced field may be used in some implementations (e.g., on a magnetic shield behind the sensor 34a. As mentioned above, the processor 35 can selectively reverse a polarity of at least one of the electromagnets 32a, 32b, 32c and/or magnetic fields M1, M2, etc., In doing so, the processor 35 can subtract an associated one of the first or second magnetic field information 44a, 44b, etc. related to selectively reversing the polarity to filter out at least one of a DC offset in the first magnetic field sensor 34a or background magnetic fields that are present in the area surrounding the assembly 10 and, in particular the sensor 34a. In addition, electromagnets 32a, 32b, 32c can be reversed in polarity, effectively making one electromagnet 32a, 32b, 32c at fixed current into the equivalent of two switchable, oppositely polarized magnetic fields. The ability to subtract one polarization over the opposite polarity is useable for subtracting DC offsets in sensor 34 or background fields for increased accuracy and sensitivity.

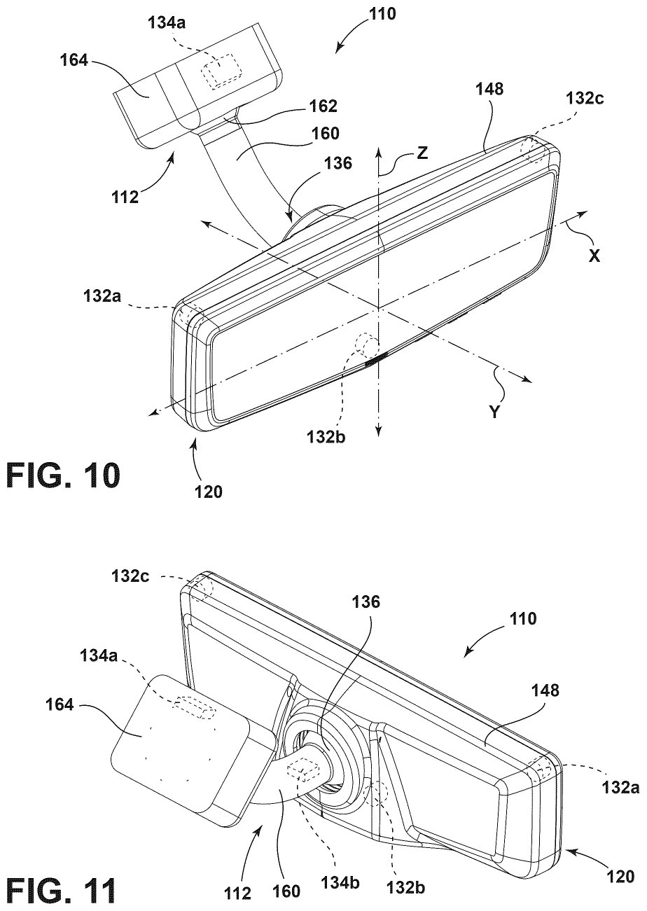

Still further, as shown in FIGS. 10 and 11, the system disclosed herein can be adapted to operate in variations of a rearview assembly 110 in which the mount 112 includes an arm 160 with a second ball joint 162 that connects the arm 160 to a base 164. In such a system, the position of the main unit 120 depends not only on the position of the main unit 120 with respect to the ball joint portion 18 with which it is immediately connected, but also the position of the second ball joint 162 with respect to the base 164. Accordingly, a variation of the present rearview assembly 110 for determining the position of the main unit 120 with respect to the base 164 can include an additional set sensor 134b embedded in the arm 160. In this manner, an additional determination can be made regarding the positioning of the arm 160 about the base 164 that can be used with the determination of the position of the main unit 120 about the arm 160 to ultimately derive the position of the main unit 120. In particular, in the depicted assembly 110, wherein the mount 112 includes a base 164 and an arm 160, the base 164 being coupled with the vehicle V at a fixed location and the arm 160 extending from the base 164 being articulable on the base 164, the main unit 120 can also be translatable along the depicted axes (X, Y, Z). As the main unit 120 is coupled to the mount 112 by being coupled with the arm 160 such that the main unit 120 is translatable with respect to the base 164. In this respect, the processor 35 can further determine a translational position of the main unit 120 with respect to the base 164 based on the information 44a, 44b associated with at least first and second magnetic fields M1, M2, generated with the magnetic field sensors 134a, 134b, etc., discussed above.

More particularly, when a determination regarding the position of the main unit 120 is desired, the position of the electromagnets 132a, 132b, 132c relative to the sensor 134a in space can be back calculated by detecting the shape of the magnetic fields M1, M2, etc. in space. In particular, the relative strength and direction of the field M1, M2, etc. for each electromagnet 132a, 132b, 132c or combination of electromagnets (as discussed above in FIGS. 9A-9D, for example) can be used to back calculate position and orientation using known magnitude and direction of the detected magnetic fields M1, M2, etc. As discussed above, the accuracy of this calculation also increases with increased numbers of electromagnets 132a, 132b, etc. and sensors 134a. It may also be possible to use a combination of electromagnets, permanent magnets, and/or magneto sensors on the main unit 120 and a combination of electromagnets, permanent magnets, and/or magneto sensors within the base 134 or adjacent the fixed location of the mount 112 with respect to the vehicle V, in general. In general, the position and orientation of the main unit 120 relative to the base 134 can be determined by first measuring the magnetic field M1, M2, etc. of various predetermined ones of the electromagnets 132a, 132b, 132c (or combinations thereof). The position of main unit 120 can be determined because the location of the magnetic fields M1, M2, etc. coil can be calculated (e.g., using Bio-Savart's Law). The overlap of the fields M1, M2 for each electromagnet 132a, 132b, etc. or combination relates to the position of the electromagnets 132a, 132b, 132c, which is correlated with the position of the main unit 120 based on the known geometry thereof. Once the position is known, the processor 135 can determine the angles of the magnetic fields M1, M2, etc. to determine the orientation of the main unit 120 relative to the mount 112, including the base 164.

As discussed above, the incorporation of additional magnetic field sensors can improve the accuracy of the calculations involved in determining the location and positioning of the main unit 120. In an example shown in FIG. 11, a second sensor 134b can be incorporated in the mount 112, particularly within the arm 160 that, as in the example of FIG. 10, is articulatable on a separate base 164 with which the arm 160 is coupled. In this respect, processor 135 can activate one or more of the electromagnets 132a, 132b, 132c within the main body 120 in various predetermined configurations thereof and can obtain magnetic field information 44 from both sensors 134a and 134b. In one example, the information from the sensor 134a in the base 164 can be used to determine the translational positioning of the main unit 120 with respect to the base 164. This information can also be used to locate the position of the ball joint portion 136, such that the information from the second sensor 134b can be used to determine the rotational position of the main unit 120 about the ball joint portion 136. In other examples, various algorithms can be used to determine the position and orientation of the main unit 120 relative to the vehicle V using magnetic field M1, M2, etc. position and vector information from both sensors 134a, 134b simultaneously.

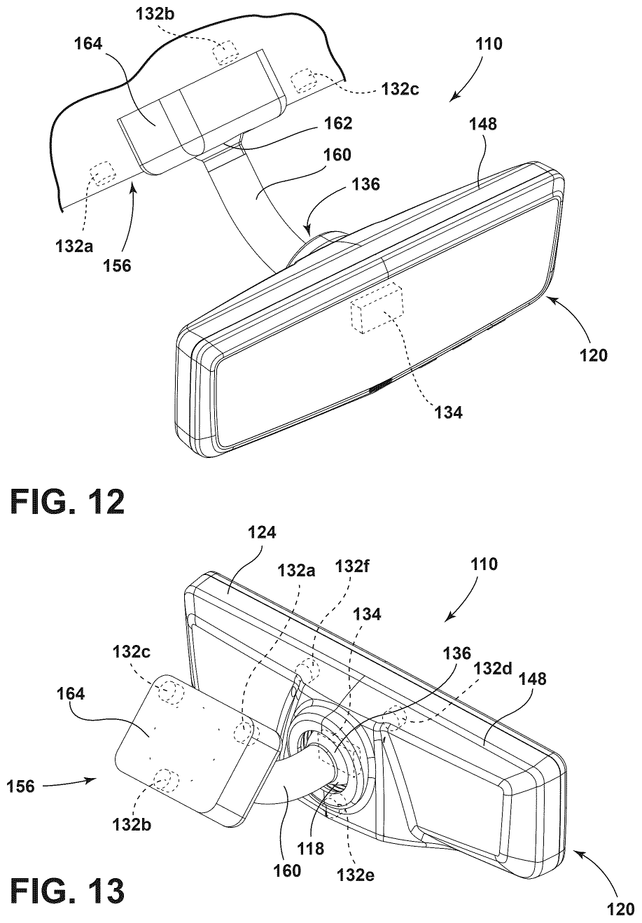

As shown in FIGS. 12 and 13, further arrangements are possible in which one or more sensors 134a are positioned within the main unit 120 with the electromagnets 132a, 132b, and (optionally) 132c positioned within a mounting structure 156 associated with the rearview assembly 110. In general, the mounting structure 156 can include mount 112 (which in the illustrated example can further include base 164 and arm 160), along with an adjacent portion of the vehicle V with which the mount 112 is fixed. In the example of FIG. 12, the mounting structure 156 can further include the portion of headliner 158 along which the mount 112 is attached, with other additional or adjacent structures, such as overhead consoles and the like being additionally or alternatively considered a part of a mounting structure 156. As shown in FIG. 12, electromagnets 132a, 132b, 132c can be fixed with the vehicle V within the headliner 158 adjacent or surrounding the mount 112. Such an arrangement can be used in a similar manner to those discussed above in which the electromagnets are within the main unit 120 to determine the position of the main unit 120 relative to the vehicle V, with the calculations being updated to account for the change in geometry. In another variation, the electromagnets 132a, 132b, 132c can be positioned within the base 164 of the mounting structure 156. In such examples, the sensor 134a can be mounted directly on the PCB 152 to which the processor 135 is mounted. In yet another example, shown in FIG. 13, the electromagnets 132a, 132b, 132c can be positioned within the base 164 of the mounting structure 156 and the sensor 134a can be mounted in the ball joint portion 118 at the end of the arm 160 such that the position of the ball joint 118 and, therefore, main unit 120 can be determined with respect to the base 164. Additional magnets 134d, 134e, can be mounted to the housing 124 of the main unit 120 within the interior of the main unit 120 in spaced apart locations about the sensor 134a. In this arrangement, the rotation of the main unit 120 about the ball joint 118 can also be determined.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A rearview assembly for a vehicle, the assembly comprising:
a mount extending from a fixed location with respect to the vehicle;
a main unit including a front face secured to a housing, the main unit being coupled to the mount such that the main unit is articulable on the mount by rotation about three perpendicular axes;
first and second electromagnets positioned within one of the mount or the housing in mutually spaced apart first locations;
a first magnetic field sensor positioned within the other of the housing and the mount;
at least one processor in communication with the first and second electromagnets and the first and second magnetic field sensors, the processor:
selectively activating the first and second electromagnets for separate generation of a first magnetic field in a first predetermined configuration and a second magnetic field in a second configuration, with the first magnetic field sensor alternately operably associated with the first magnetic field and the second magnetic field; and
receiving first magnetic field information related to the first magnetic field and second magnetic field information related to the second magnetic field from the first magnetic field sensor and determining a rotational position of the main unit in relation to the mount about each of the three perpendicular axes based on the first and second magnetic field information.

2. The rearview assembly of claim 1, wherein:
selectively activating the first and second electromagnets includes activating the first electromagnet with the second electromagnet deactivated; and
the processor determines the rotational position of the main unit in relation to the mount about at least one of the three perpendicular axes based on the first magnetic field information from the first magnetic field sensor during activation of the first electromagnet with the second electromagnet deactivated.

3. The rearview assembly of claim 2, wherein:
selectively activating the first and second electromagnets further includes subsequently activating the second electromagnet with the first electromagnet deactivated; and
the processor determines the rotational position of the main unit in relation to the mount about at least a remaining one of the three perpendicular axes based on the second magnetic field information from the first magnetic field sensor during activation of the second electromagnet with the first electromagnet deactivated.

4. The rearview assembly of claim 2, wherein the first and second electromagnets each have a respective magnetic field orientation, the respective directions of the first and second electromagnets being substantially perpendicular.

5. The rearview assembly of claim 1, further including a third electromagnet positioned within the one of the mount or the housing with the first and second electromagnets in the mutually spaced apart first locations, wherein the processor further:
selectively activates the first, second, and third electromagnets for separate generation the first and second magnetic fields.

6. The rearview assembly of claim 5, wherein:
the first and second electromagnets are positioned within the housing at opposite first and second lateral sides toward an upper edge thereof; and
the third electromagnet is positioned toward a center of the housing and toward a lower edge thereof.

7. The rearview assembly of claim 5, wherein:
the mount includes a base and an arm, the base coupled with the vehicle at the fixed location and the arm extending from the base and being coupled to the base such that the arm is articulable on the base;
the main unit is coupled to the mount by being coupled with the arm such that the main unit is translatable with respect to the base; and
the processor further determines a translational position of the main unit with respect to the base based on the first and second magnetic field information.

8. The rearview assembly of claim 1, wherein:
the mount includes a base and an arm, the base coupled with the vehicle at the fixed location and the arm extending from the base and being coupled to the base such that the arm is articulable on the base;
the main unit is coupled to the mount by being coupled with the arm such that the main unit is translatable with respect to the base;
the first magnetic field sensor is positioned within the arm of the mount;
the rearview assembly further includes a second magnetic field sensor positioned within the base of the mount; and
the processor further receiving first magnetic field information related to the first magnetic field and second magnetic field information related to the second magnetic field from the second magnetic field sensor and determines both the rotational position of the main unit in relation to the mount about each of the three perpendicular axes and a translational position of the main unit with respect to the base based on the first and second magnetic field information.

9. The rearview assembly of claim 1, wherein the processor further:
selectively reverses a polarity of at least one of the first electromagnet, the second electromagnet, the first magnetic field, and the second magnetic field; and
subtracts an associated one of the first or second magnetic field data related to selectively reversing the polarity to filter out at least one of a DC offset in the first magnetic field sensor or background magnetic fields.

10. A rearview assembly for a vehicle, the assembly comprising:
a mount extending from a fixed location adjacent a headliner of the vehicle;
a main unit including a front face secured to a housing, the main unit being coupled to the mount such that the main unit is articulable on the mount by rotation about three perpendicular axes;
first and second electromagnets positioned within the headliner in mutually spaced apart first locations;
a first magnetic field sensor positioned within the housing;
at least one processor in communication with the first and second electromagnets and the first and second magnetic field sensors, the processor:
selectively activating the first and second electromagnets for separate generation of a first magnetic field in a first predetermined configuration and a second magnetic field in a second configuration, with the first magnetic field sensor alternately operably associated with the first magnetic field and the second magnetic field; and
receiving first magnetic field information related to the first magnetic field and second magnetic field information related to the second magnetic field from the first magnetic field sensor and determining a rotational position of the main unit in relation to the mount about each of the three perpendicular axes based on the first and second magnetic field information.

11. The rearview assembly of claim 10, wherein:
selectively activating the first and second electromagnets includes activating the first electromagnet with the second electromagnet deactivated; and
the processor determines the rotational position of the main unit in relation to the mount about at least one of the three perpendicular axes based on the magnetic field information from the first magnetic field sensor during activation of the first electromagnet with the second electromagnet deactivated.

12. The rearview assembly of claim 11, wherein:
selectively activating the first and second electromagnets further includes subsequently activating the second electromagnet with the first electromagnet deactivated; and
the processor determines the rotational position of the main unit in relation to the mount about at least a remaining one of the three perpendicular axes based on the first magnetic field information from the first magnetic field sensor during activation of the second electromagnet with the first electromagnet deactivated.

13. The rearview assembly of claim 11, wherein the first and second electromagnets each have a respective magnetic field orientation, the respective directions of the first and second electromagnets being substantially perpendicular.

14. The rearview assembly of claim 10, further including a third electromagnet positioned within headliner with the first and second electromagnets in the mutually spaced apart first locations, wherein the processor further:
selectively activates the first, second, and third electromagnets for separate generation of the first and second magnetic fields.

15. A rearview assembly for a vehicle, the assembly comprising:
a mounting structure extending from a fixed location with respect to the vehicle;
a main unit including a front face secured to a housing, the main unit being coupled to the mounting structure such that the main unit is articulable on the mount by rotation about three perpendicular axes;
first, second, and third electromagnets positioned within one of the mounting structure or the housing in mutually spaced apart first locations;
a first magnetic field sensor positioned within the other of the housing and the mounting structure;
at least one processor in communication with the first, second, and third electromagnets and the first and second magnetic field sensors, the processor:
selectively activating the first, second, and third electromagnets for separate generation of a first magnetic field in a first predetermined configuration and a second magnetic field in a second configuration, with the first magnetic field sensor alternately operably associated with the first magnetic field and the second magnetic field; and
receiving first magnetic field information related to the first magnetic field and second magnetic field information related to the second magnetic field from the first magnetic field sensor and determining a rotational position of the main unit in relation to the mount about each of the three perpendicular axes based on the first and second magnetic field information.

16. The rearview assembly of claim 15, wherein the processor further:
selectively activates the first, second, and third electromagnets for separate generation of a third magnetic field in a third predetermined configuration, with the magnetic field sensor further alternately operably associated with the third magnetic field; and
receives third magnetic field information related to the third magnetic field from the first magnetic field sensor and determines the rotational position of the main unit in relation to the mounting structure about each of the three perpendicular axes based on the first, second, and third magnetic field information.

17. The rearview assembly of claim 16, wherein:
the first and second electromagnets are positioned within the housing at opposite first and second lateral sides toward an upper edge thereof; and
the third electromagnet is positioned toward a center of the housing and toward a lower edge thereof.

18. The rearview assembly of claim 15, wherein:
the mounting structure includes a base and an arm, the base coupled with the vehicle at the fixed location and the arm extending from the base and being coupled to the base such that the arm is articulable on the base;
the main unit is coupled to the mount by being coupled with the arm such that the main unit is translatable with respect to the base; and
the processor further determines a translational position of the main unit with respect to the base based on the first and second magnetic field information.

19. The rearview assembly of claim 15, wherein:
the mounting structure includes a mount positioned at the fixed location adjacent a headliner of the vehicle; and
the first and second electromagnets positioned within the headliner in mutually spaced apart first locations around the mount.

20. The rearview assembly of claim 15, wherein the processor further:
selectively reverses a polarity of at least one of the first electromagnet, the second electromagnet, the first magnetic field; and
subtracts an associated one of the first or second magnetic field data related to selectively reversing the polarity to filter out at least one of a DC offset in the first magnetic field sensor or background magnetic fields.
